(19) United States
(12) Patent Application Publication
(10) Pub. No.: US 2026/0217246 A1
(43) Pub. Date: Jul. 30, 2026

(54) CONTROL APPARATUS AND CONTROL METHOD

(71) Applicant: Robert Bosch GmbH, Stuttgart (DE)

(72) Inventor: Tomohiro Shoji, Kanagawa (JP)

(21) Appl. No.: 19/143,725

(22) PCT Filed: Dec. 30, 2023
(86) PCT No.: PCT/IB2023/063403

§ 371 Date: Jun. 26, 2025

(30) Foreign Application Priority Data
Jan. 5, 2023 (JP) 2023-000744

(51) Int. Cl. B60W 30/12; B60W 30/16; B60W 50/14

(52) U.S. Cl. CPC B60W 30/12; B60W 30/16; B60W 50/14; B60W 2300/36; B60W 2420/403; B60W 2554/402; B60W 2554/4048; B60W 2554/801; B60W 2754/20; B60W 2754/30

(57) ABSTRACT

The present invention provides a control apparatus and a control method capable of improving the safety of a straddle-type vehicle.

In a control apparatus 20 and a control method according to the present invention, an execution section of the control apparatus 20 executes a rider support operation for supporting driving by a rider, and a determination section of the control apparatus 20 determines the visibility of a straddle-type vehicle 1 from an oncoming vehicle. The execution section executes, based on a visibility determination result from the determination section, a traveling position support operation which is the rider support operation of recommending or correcting the traveling position of the straddle-type vehicle 1 in a lane width direction.

### BACKGROUND

The present disclosure relates to a control apparatus and a control method capable of improving the safety of a straddle-type vehicle.

Conventionally, various techniques of supporting driving of a straddle-type vehicle such as a motorcycle by a rider have been proposed. For example, JP2009-116882A discloses a driver support system for warning a rider on a motorcycle about improper approaching to an obstacle present in a traveling direction or substantially in the traveling direction based on information detected by a sensor apparatus that detects the obstacle.

### SUMMARY

A straddle-type vehicle has a higher degree of freedom in a traveling position in a lane width direction as compared to, e.g., a four-wheeled motor vehicle. There may be a situation where a straddle-type vehicle, a leading vehicle traveling ahead of the straddle-type vehicle, and an oncoming vehicle traveling in a direction opposite to a traveling direction of the straddle-type vehicle and the leading vehicle are present. In some cases under such a situation, depending on the traveling position of the straddle-type vehicle in the lane width direction, the straddle-type vehicle is hidden behind the leading vehicle as viewed from the oncoming vehicle, and is in a blind area within the field of view of the oncoming vehicle. In this case, for example, when the oncoming vehicle turns right to a traveling lane side on which the straddle-type vehicle travels, there is a probability that the oncoming vehicle and the straddle-type vehicle collide with each other. For this reason, there has been a demand for improvement in the safety of the straddle-type vehicle.

The present invention has been made in view of the above-described problems, and provides a control apparatus and a control method capable of improving the safety of a straddle-type vehicle.

The control apparatus according to the present invention is a control apparatus for a rider support system for supporting driving of a straddle-type vehicle by a rider. The control apparatus includes an execution section that executes a rider support operation for supporting driving by the rider, and a determination section that determines the visibility of the straddle-type vehicle from an oncoming vehicle. The execution section executes, based on a visibility determination result from the determination section, a traveling position support operation which is the rider support operation of recommending or correcting the traveling position of the straddle-type vehicle in a lane width direction.

The control method according to the present invention is a control method for a rider support system for supporting driving of a straddle-type vehicle by a rider. The control method includes an execution section of a control apparatus executing a rider support operation for supporting driving by the rider, and a determination section of the control apparatus determining the visibility of the straddle-type vehicle from an oncoming vehicle. The execution section executes, based on a visibility determination result from the determination section, a traveling position support operation which is the rider support operation of recommending or correcting the traveling position of the straddle-type vehicle in a lane width direction.

In the control apparatus and the control method according to the present invention, the execution section of the control apparatus executes the rider support operation for supporting driving by the rider, and the determination section of the control apparatus determines the visibility of the straddle-type vehicle from the oncoming vehicle. The execution section executes, based on the visibility determination result from the determination section, the traveling position support operation which is the rider support operation of recommending or correcting the traveling position of the straddle-type vehicle in the lane width direction. With this configuration, entrance of the straddle-type vehicle into a blind area within the field of view of the oncoming vehicle can be reduced, and therefore, e.g., occurrence of collision between the oncoming vehicle and the straddle-type vehicle can be reduced. Thus, the safety of the straddle-type vehicle can be improved.

### BRIEF DESCRIPTION OF DRAWINGS

FIG. 1 is a schematic view showing an outline configuration of a straddle-type vehicle according to an embodiment of the present invention.

FIG. 2 is a block diagram showing one example of a functional configuration of a control apparatus according to the embodiment of the present invention.

FIG. 3 is a view showing a state in which for the straddle-type vehicle according to the embodiment of the present invention, a leading vehicle and an oncoming vehicle are present.

FIG. 4 is a flowchart showing one example of the flow of processing performed by the control apparatus according to the embodiment of the present invention.

### DETAILED DESCRIPTION

Hereinafter, a control apparatus and a control method according to the present invention will be described with reference to the drawings.

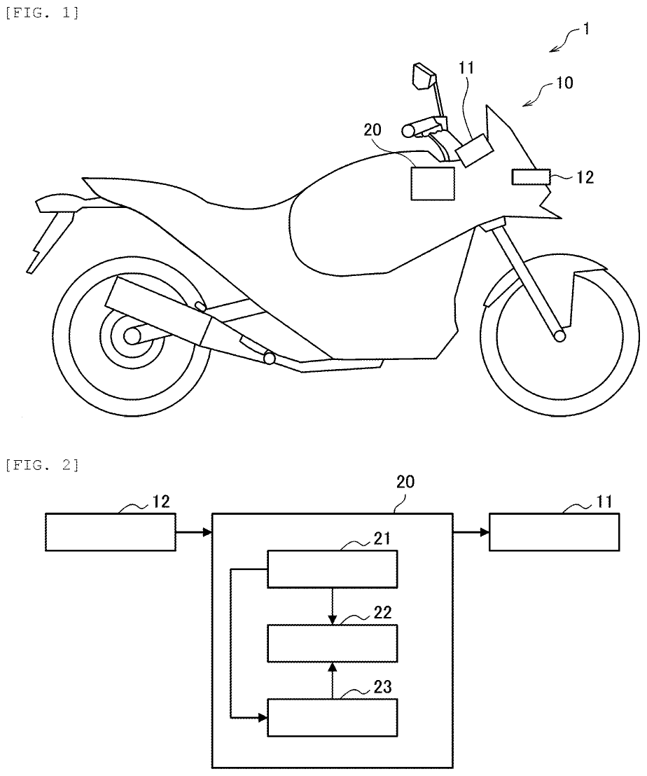

Note that a control apparatus used for a two-wheeled motorcycle will be described hereinafter (see a straddle-type vehicle 1 in FIG. 1), but a vehicle targeted for control by the control apparatus according to the present invention may be a straddle-type vehicle other than the two-wheeled motorcycle. The straddle-type vehicle means a vehicle on which a rider straddles. The straddle-type vehicle includes, for example, a motorcycle (motorbike, motor tricycle) and a bicycle. The motorcycle includes a vehicle using an engine as a power source, a vehicle using an electric motor as a power source, etc. The motorcycle includes, for example, a bike, a scooter, and an electric scooter. The bicycle means a vehicle which can be driven on a road with pedal effort which is applied to a pedal by a rider. The bicycle includes a regular bicycle, a power-assisted bicycle, an electric bicycle, etc.

Configurations, operations, etc. described below are one example, and the control apparatus and the control method according to the present invention are not limited to these configurations, operations, etc.

The same or similar description will be summarized or omitted hereinafter as necessary. Further, in each figure, the same or similar members or portions are assigned with no reference numerals, or are assigned with the same reference numerals. In addition, detailed structures are simplified or omitted in each figure as necessary.

### Configuration of Straddle-Type Vehicle

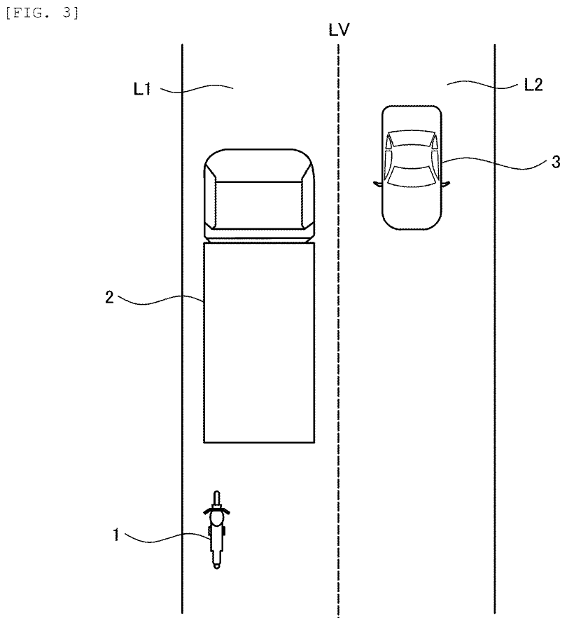

The configuration of the straddle-type vehicle 1 according to the embodiment of the present invention will be described with reference to FIGS. 1 and 2.

FIG. 1 is a schematic view showing an outline configuration of the straddle-type vehicle 1. The straddle-type vehicle 1 is a two-wheeled motorcycle equivalent to one example of the straddle-type vehicle according to the present invention. As shown in FIG. 1, the straddle-type vehicle 1 includes a display apparatus 11, a surrounding environment sensor 12, and a control apparatus (ECU) 20.

The straddle-type vehicle 1 includes a rider support system 10 that supports a rider on the straddle-type vehicle 1. The rider support system 10 includes the above-described components (specifically, display apparatus 11, surrounding environment sensor 12, and control apparatus 20).

The display apparatus 11 has a display function of visually displaying information. The display apparatus 11 includes, for example, a liquid crystal display. The display apparatus 11 is provided, for example, to the front of the straddle-type vehicle 1 with respect to handlebars. Note that arrangement of the display apparatus 11 on a vehicle body is not particularly limited.

The surrounding environment sensor 12 detects surrounding environment information about environment surrounding the straddle-type vehicle 1. Specifically, the surrounding environment sensor 12 is provided to a front portion of the straddle-type vehicle 1, and detects surrounding environment information on the front of the straddle-type vehicle 1. The surrounding environment information detected by the surrounding environment sensor 12 is output to the control apparatus 20.

The surrounding environment information detected by the surrounding environment sensor 12 may be information (e.g., relative position, relative distance, relative speed, and relative acceleration) on a distance or an orientation to a subject positioned at the periphery of the straddle-type vehicle 1, or may be the characteristics (e.g., the type of subject, the shape of the subject itself, and a mark attached to the subject) of the subject positioned at the periphery of the straddle-type vehicle 1. The surrounding environment sensor 12 includes, for example, a radar, a Lidar sensor, an ultrasonic sensor, and a camera.

Note that the surrounding environment information may be detected by surrounding environment sensors mounted on other vehicles or infrastructure equipment. That is, the control apparatus 20 can acquire the surrounding environment information via wireless communication with the other vehicles or the infrastructure equipment.

The control apparatus 20 controls operation of the rider support system 10. For example, part or the entirety of the control apparatus 20 includes a microcomputer, a microprocessor unit, etc. Alternatively, for example, part or the entirety of the control apparatus 20 may include, e.g., updatable firmware, or may be, e.g., a program module to be executed according to a command from a CPU. The control apparatus 20 may include, for example, one apparatus or a plurality of divided apparatuses.

As shown in FIG. 2, the control apparatus 20 includes, for example, an acquisition section 21, an execution section 22, and a determination section 23. The control apparatus 20 communicates with each apparatus (e.g., display apparatus 11 and surrounding environment sensor 12) of the rider support system 10. Moreover, the control apparatus 20 can control operation of each apparatus (e.g., display apparatus 11) of the rider support system 10.

The acquisition section 21 acquires information from each apparatus of the rider support system 10, and outputs the information to the execution section 22 and the determination section 23. For example, the acquisition section 21 acquires information from the surrounding environment sensor 12. Note that in the present specification, information acquisition may include, e.g., information extraction or generation (e.g., arithmetic processing).

The execution section 22 executes a rider support operation. The rider support operation is an operation for supporting driving of the straddle-type vehicle 1 by the rider, and may include various types of operation. Particularly, the execution section 22 executes a traveling position support operation which is the rider support operation of recommending or correcting the traveling position of the straddle-type vehicle 1 in a lane width direction. For example, the execution section 22 controls operation of the display apparatus 11, thereby executing the traveling position support operation. In the present embodiment, the safety of the straddle-type vehicle 1 is improved by such a traveling position support operation, as described later.

The determination section 23 performs various types of determination. A determination result from the determination section 23 is used for processing performed by the execution section 22.

### Operation of Control Apparatus

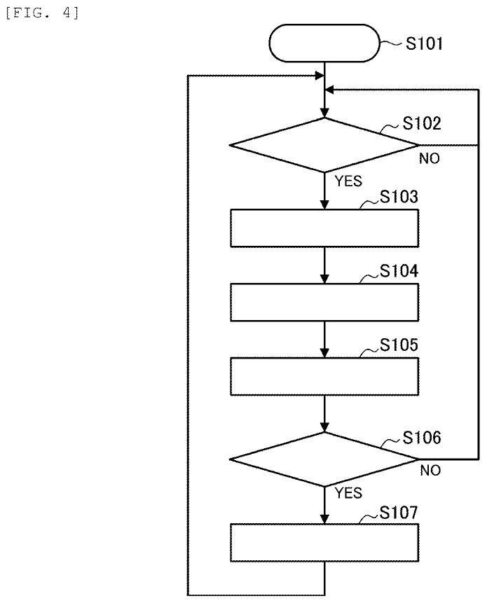

Operation of the control apparatus 20 according to the embodiment of the present invention will be described with reference to FIGS. 3 and 4.

As described above, the execution section 22 of the control apparatus 20 executes the traveling position support operation which is the rider support operation of recommending or correcting the traveling position of the straddle-type vehicle 1 in the lane width direction. The traveling position support operation is performed for reducing entrance of the straddle-type vehicle 1 into a blind area within the field of view of an oncoming vehicle in a situation where the straddle-type vehicle 1, a leading vehicle traveling ahead of the straddle-type vehicle 1, and the oncoming vehicle traveling in a direction opposite to a traveling direction of the straddle-type vehicle 1 and the leading vehicle are present.

FIG. 3 shows a state in which for the straddle-type vehicle 1, a leading vehicle 2 and an oncoming vehicle 3 are present. In the example of FIG. 3, a lane L1 and a lane L2 are adjacent to each other through a lane boundary LV. A traveling direction on the lane L1 is the upward direction in FIG. 3, and a traveling direction on the lane L2 is the downward direction in FIG. 3.

That is, the traveling direction on the lane L1 and the traveling direction on the lane L2 are opposite to each other.

The straddle-type vehicle 1 travels on the lane L1. That is, the lane L1 is equivalent to a traveling lane for the straddle-type vehicle 1. The leading vehicle 2 is positioned in front on the lane L1. In the example of FIG. 3, the leading vehicle 2 is a large truck. Note that the leading vehicle 2 may be a vehicle other than the large truck. With reference to the straddle-type vehicle 1, the lane L2 is equivalent to an oncoming lane. The oncoming vehicle 3 travels on the lane L2. In a front-rear direction (upper-lower direction in FIG. 3), the oncoming vehicle 3 is positioned in the vicinity of a front portion of the leading vehicle 2. Moreover, in the front-rear direction (upper-lower direction in FIG. 3), the oncoming vehicle 3 is positioned in front of the straddle-type vehicle 1.

The straddle-type vehicle 1 has a higher degree of freedom in the traveling position in the lane width direction as compared to, e.g., a four-wheeled motor vehicle. The lane width direction means a width direction (right-left direction in FIG. 3) perpendicular to the traveling direction on the lane. In the example of FIG. 3, the traveling position of the straddle-type vehicle 1 in the lane width direction is on the left side on the lane L1. For this reason, the straddle-type vehicle 1 is hidden behind the leading vehicle 2 as viewed from the oncoming vehicle 3, and tends to be in the blind area within the field of view of the oncoming vehicle 3. According to the control apparatus 20, entrance of the straddle-type vehicle 1 into the blind area within the field of view of the oncoming vehicle 3 is reduced by the traveling position support operation.

Hereinafter, one example of the flow of processing performed by the control apparatus 20 will be described with reference to FIG. 4. Note that an example where the traveling position of the straddle-type vehicle 1 in the lane width direction is recommended in the traveling position support operation will be mainly described hereinafter. Note that as described later, the traveling position of the straddle-type vehicle 1 in the lane width direction may be corrected in the traveling position support operation.

FIG. 4 is a flowchart showing one example of the flow of the processing performed by the control apparatus 20. Step S101 in FIG. 4 corresponds to the start of the control flow shown in FIG. 4.

When the control flow shown in FIG. 4 starts, the determination section 23 determines, in Step S102, whether the oncoming lane is present. Note that such an oncoming lane means a lane (lane L2 in the example of FIG. 3) on which a traveling direction is opposite to that on a lane on which the straddle-type vehicle 1 travels.

The determination section 23 can determine, based on the surrounding environment information obtained from, e.g., the surrounding environment sensor 12, whether the oncoming lane is present. For example, in a case where a camera facing the front of the straddle-type vehicle 1 is used as the surrounding environment sensor 12, the determination section 23 can determine whether the oncoming lane is present by performing image recognition processing on an image obtained by the camera.

Note that the determination section 23 may determine, by a method other than the above-described method, whether the oncoming lane is present. For example, the determination section 23 may determine, using map information obtained from, e.g., a navigation apparatus, whether the oncoming lane is present.

In a case where it is determined that no oncoming lane is present (Step S102/NO), Step S102 is repeated. On the other hand, in a case where it is determined that the oncoming lane is present (Step S102/YES), the processing proceeds to Step S103.

In a case where it is determined as YES in Step S102, the acquisition section 21 acquires, in Step S103, traveling position information on the straddle-type vehicle 1.

The traveling position information is information about the traveling position of the straddle-type vehicle 1. Particularly, the traveling position information includes information on the traveling position of the straddle-type vehicle 1 on the traveling lane (lane L1 in the example of FIG. 3), and for example, may include information on the traveling position of the straddle-type vehicle 1 in the lane width direction on the traveling lane.

The acquisition section 21 can acquire the traveling position information on the straddle-type vehicle 1, for example, based on the surrounding environment information obtained from, e.g., the surrounding environment sensor 12. For example, in a case where the camera facing the front of the straddle-type vehicle 1 is used as the surrounding environment sensor 12, the acquisition section 21 can acquire the traveling position information by performing the image recognition processing on the image obtained by the camera. For example, the acquisition section 21 can acquire, as the traveling position information, information on the traveling position of the straddle-type vehicle 1 in the lane width direction on the traveling lane based on the display position of a white line of the traveling lane on the image obtained by the camera.

Note that the acquisition section 21 may acquire the traveling position information by a method other than the above-described method. For example, the acquisition section 21 can acquire, using, e.g., the navigation apparatus, positioning data indicating the current position of the straddle-type vehicle 1 based on information transmitted from a global positioning system (GPS) satellite. The acquisition section 21 may acquire the traveling position information by checking the positioning data obtained on the straddle-type vehicle 1 as described above and map data acquired from, e.g., the navigation apparatus against each other.

After Step S103, the acquisition section 21 acquires information about the leading vehicle 2 in Step S104. Particularly, the acquisition section 21 acquires, as such information, positional relationship information on the straddle-type vehicle 1 and the leading vehicle 2.

The positional relationship information on the straddle-type vehicle 1 and the leading vehicle 2 is information about a positional relationship between the straddle-type vehicle 1 and the leading vehicle 2, and for example, may include information such as the position, distance, speed, acceleration, or jerk of the straddle-type vehicle 1 relative to the leading vehicle 2 or a passage time difference between the straddle-type vehicle 1 and the leading vehicle 2. The positional relationship information may include information on a component in the lane width direction and information on a component in the front-rear direction. Alternatively, the positional relationship information may include not only a current positional relationship between the straddle-type vehicle 1 and the leading vehicle 2, but also information about a positional relationship estimated in the future. Alternatively, the positional relationship information may be information on other physical amounts which can be substantially converted into these types of information. Note that the passage time difference means a time taken from a current point until the straddle-type vehicle 1 passes the current position of the leading vehicle 2 in the front-rear direction. The positional relationship information may be acquired, for example, based on the surrounding environment information obtained from, e.g., the surrounding environment sensor 12.

Note that in Step S104, the acquisition section 21 may acquire, as the information about the leading vehicle 2, information other than the positional relationship information. For example, the acquisition section 21 may acquire information on the dimension (e.g., length in the front-rear direction and length in the lane width direction) of the leading vehicle 2 based on the surrounding environment information obtained from, e.g., the surrounding environment sensor 12.

After Step S104, the acquisition section 21 acquires information about the oncoming vehicle 3 in Step S105. Particularly, the acquisition section 21 acquires, as such information, positional relationship information on the straddle-type vehicle 1 and the oncoming vehicle 3.

The positional relationship information on the straddle-type vehicle 1 and the oncoming vehicle 3 is information about a positional relationship between the straddle-type vehicle 1 and the oncoming vehicle 3, and for example, may include information such as the position, distance, speed, acceleration, or jerk of the straddle-type vehicle 1 relative to the oncoming vehicle 3 or a passage time difference between the straddle-type vehicle 1 and the oncoming vehicle 3. The positional relationship information may include information on a component in the lane width direction and information on a component in the front-rear direction. Alternatively, the positional relationship information may include not only a current positional relationship between the straddle-type vehicle 1 and the oncoming vehicle 3, but also information about a positional relationship estimated in the future. Alternatively, the positional relationship information may be information on other physical amounts which can be substantially converted into these types of information. Note that the passage time difference means a time taken from a current point until the straddle-type vehicle 1 passes the current position of the oncoming vehicle 3 in the front-rear direction. The positional relationship information may be acquired, for example, based on the surrounding environment information obtained from, e.g., the surrounding environment sensor 12.

Note that in Step S105, the acquisition section 21 may acquire, as the information about the oncoming vehicle 3, information other than the positional relationship information. For example, the acquisition section 21 may acquire information on the dimension (e.g., length in the front-rear direction and length in the lane width direction) of the oncoming vehicle 3 based on the surrounding environment information obtained from, e.g., the surrounding environment sensor 12.

After Step S105, the determination section 23 determines, in Step S106, whether the visibility of the straddle-type vehicle 1 from the oncoming vehicle 3 is lower than a reference.

In other words, the visibility of the straddle-type vehicle 1 from the oncoming vehicle 3 means the ease of visual recognition of the straddle-type vehicle 1 within the field of view of the oncoming vehicle 3. The reference in Step S106 is set so that it can be properly determined whether the entirety or a large portion of the straddle-type vehicle 1 is in the blind area within the field of view of the oncoming vehicle 3. A case where the visibility of the straddle-type vehicle 1 from the oncoming vehicle 3 is lower than the reference is equivalent to a case where it can be determined that the entirety or the large portion of the straddle-type vehicle 1 is in the blind area within the field of view of the oncoming vehicle 3.

For example, in a case where the camera facing the front of the straddle-type vehicle 1 is used as the surrounding environment sensor 12, the determination section 23 can determine the visibility based on the image obtained by the camera. The image obtained by the camera may show the leading vehicle 2. The determination section 23 may perform, for example, image recognition processing on the image obtained by the camera, thereby acquiring information on the size of the leading vehicle 2 on the image. Based on such information, the determination section 23 may determine the visibility. For example, in a case where the percentage of the area of a region on which the leading vehicle 2 is shown with respect to the area of the entire image obtained by the camera is greater than a threshold, it may be determined that the visibility is lower than the reference.

In this example, the determination section 23 takes the image obtained by the camera as the field of view of the straddle-type vehicle 1, thereby determining the visibility of the oncoming vehicle 3 from the straddle-type vehicle 1. Further, the determination section 23 takes the visibility of the oncoming vehicle 3 from the straddle-type vehicle 1 as being equal to the visibility of the straddle-type vehicle 1 from the oncoming vehicle 3, thereby determining the visibility of the straddle-type vehicle 1 from the oncoming vehicle 3.

Considering improvement in the accuracy of determination on the visibility, the determination section 23 preferably determines the visibility based not only on the information on the size of the leading vehicle 2 on the image obtained by the camera, but also on the information on the traveling position of the straddle-type vehicle 1 in the lane width direction.

For example, in a case where the percentage of the area of the region on which the leading vehicle 2 is shown with respect to the area of the entire image obtained by the camera is greater than the threshold, the determination section 23 may determine that the visibility is lower than the reference only in a case where the traveling position of the straddle-type vehicle 1 in the lane width direction is on the left side on the traveling lane (lane L1 in the example of FIG. 3) as in the example of FIG. 3. Thus, for example, erroneous determination as the visibility being lower than the reference can be reduced in a case where the traveling position of the straddle-type vehicle 1 in the lane width direction is on the right side on the traveling lane and the straddle-type vehicle 1 is not in the blind area within the field of view of the oncoming vehicle 3.

The example where the visibility is determined based on the information on the size of the leading vehicle 2 on the image has been described above as the method for determining the visibility based on the image obtained by the camera. Note that the method for determining the visibility based on the image obtained by the camera is not limited to this example. For example, the determination section 23 may determine the visibility based on information on timing of the image obtained by the camera showing the oncoming vehicle 3. For example, in a case where the image starts showing the oncoming vehicle 3 at timing when the straddle-type vehicle 1 and the oncoming vehicle 3 are close to each other in distance in the front-rear direction, the determination section 23 may determine that the visibility is lower than the reference. For example, in a case where a time for which the image shows the oncoming vehicle 3 is shorter than a reference time, the determination section 23 may determine that the visibility is lower than the reference.

The example where the visibility is determined based on the image obtained by the camera has been described above. Note that the determination section 23 may determine the visibility using information other than the image obtained by the camera. For example, the determination section 23 may determine the visibility based on the positional relationship information on the straddle-type vehicle 1 and the leading vehicle 2 and the positional relationship information on the straddle-type vehicle 1 and the oncoming vehicle 3. Using these types of positional relationship information, the determination section 23 can grasp a positional relationship among the straddle-type vehicle 1, the leading vehicle 2, and the oncoming vehicle 3. Thus, the determination section 23 can determine whether the straddle-type vehicle 1 is hidden behind the leading vehicle 2 as viewed from the oncoming vehicle 3 and the entirety or the large portion of the straddle-type vehicle 1 is in the blind area within the field of view of the oncoming vehicle 3, and can determine the visibility.

For example, the determination section 23 can specify, based on the positional relationship information, such an area of the traveling position of the straddle-type vehicle 1 that the visibility of the straddle-type vehicle 1 from the oncoming vehicle 3 is at a higher level than the reference (i.e., the straddle-type vehicle 1 is not in the blind area or is in the blind area only for a short time within the field of view of the oncoming vehicle 3). The area changes according to, e.g., the position, distance, speed, acceleration, or jerk of the straddle-type vehicle 1 relative to the leading vehicle 2 or the passage time difference between the straddle-type vehicle 1 and the leading vehicle 2 and the position, distance, speed, acceleration, or jerk of the straddle-type vehicle 1 relative to the oncoming vehicle 3 or the passage time difference between the straddle-type vehicle 1 and the oncoming vehicle 3. The determination section 23 determines that the visibility is higher than the reference in a case where the traveling position of the straddle-type vehicle 1 is within the area, and determines that the visibility is lower than the reference in a case where the traveling position of the straddle-type vehicle 1 is outside the area.

Note that the determination section 23 may determine the visibility based on one of the positional relationship information on the straddle-type vehicle 1 and the leading vehicle 2 or the positional relationship information on the straddle-type vehicle 1 and the oncoming vehicle 3. For example, the determination section 23 may specify such an area of the traveling position of the straddle-type vehicle 1 that the visibility of the straddle-type vehicle 1 from the oncoming vehicle 3 is at a higher level than the reference based on one of the positional relationship information on the straddle-type vehicle 1 and the leading vehicle 2 or the positional relationship information on the straddle-type vehicle 1 and the oncoming vehicle 3, and may determine the visibility based on the area.

Two types of methods including the method for determining the visibility based on the image obtained by the camera and the method for determining the visibility based on the positional relationship information on the straddle-type vehicle 1 and the other vehicles have been described above as the method for determining the visibility. Only one of these two types of methods may be performed, or both these two methods may be used in combination. For example, in a case where it is determined, as a result of determination on the visibility by two types of methods, that the visibility of the straddle-type vehicle 1 from the oncoming vehicle 3 is lower than the reference in determination on the visibility at least by one type of method, it may be determined as YES in Step S106.

In a case where it is determined that the visibility of the straddle-type vehicle 1 from the oncoming vehicle 3 is higher than the reference (Step S106/NO), the processing returns to Step S102. On the other hand, in a case where the visibility of the straddle-type vehicle 1 from the oncoming vehicle 3 is lower than the reference (Step S106/YES), the processing proceeds to Step S107.

In a case where it is determined as YES in Step S106, the execution section 22 executes the traveling position support operation in Step S107, and the processing returns to Step S102. In the traveling position support operation, the execution section 22 recommends the traveling position of the straddle-type vehicle 1 in the lane width direction to the rider. Specifically, in the traveling position support operation, the execution section 22 recommends, to the rider, such a traveling position in the lane width direction that the visibility of the straddle-type vehicle 1 from the oncoming vehicle 3 is at a higher level than the reference (i.e., the straddle-type vehicle 1 is not in the blind area or is in the blind area only for a short time within the field of view of the oncoming vehicle 3).

For example, using the display apparatus 11, the execution section 22 notifies the rider of the recommended traveling position in the lane width direction. Note that recommendation of the traveling position in the lane width direction by the traveling position support operation is not limited to the example using the display apparatus 11. For example, in the traveling position support operation, the traveling position in the lane width direction may be recommended using a display apparatus mounted on an item (e.g., helmet or gloves) worn by the rider. Alternatively, for example, in the traveling position support operation, the traveling position in the lane width direction may be recommended using sound. In this case, in the traveling position support operation, the traveling position in the lane width direction may be recommended, for example, using a sound output apparatus mounted on the straddle-type vehicle 1 or the item worn by the rider.

For example, the execution section 22 recommends a right traveling position on the traveling lane in the traveling position support operation. This prompts the rider to perform an operation of moving the straddle-type vehicle 1 to the right side. Thus, entrance of the straddle-type vehicle 1 into the blind area within the field of view of the oncoming vehicle 3 can be reduced, and the safety of the straddle-type vehicle 1 can be improved.

Considering effective reduction in entrance of the straddle-type vehicle 1 into the blind area within the field of view of the oncoming vehicle 3, the execution section 22 preferably executes the traveling position support operation using not only the visibility determination result but also various types of information.

The execution section 22 may execute the traveling position support operation, for example, based not only on the visibility determination result but also on the information on the traveling position of the straddle-type vehicle 1. For example, the closer the traveling position of the straddle-type vehicle 1 in the lane width direction is to the left end of the traveling lane, the more the straddle-type vehicle 1 needs to be moved to the right side in order to reduce entrance of the straddle-type vehicle 1 into the blind area within the field of view of the oncoming vehicle 3. Thus, in the traveling position support operation, the execution section 22 may notify the rider that the recommended traveling position in the lane width direction is closer to the right side with respect to the current traveling position as the traveling position of the straddle-type vehicle 1 in the lane width direction is closer to the left end of the traveling lane.

The traveling position information on the straddle-type vehicle 1 may include not only the information on the traveling position of the straddle-type vehicle 1 in the lane width direction, but also information on the traveling position of the straddle-type vehicle 1 in the front-rear direction. The execution section 22 may execute the traveling position support operation based not only on the visibility determination result but also on the information on the traveling position of the straddle-type vehicle 1 in the front-rear direction. The shorter an inter-vehicular distance between the straddle-type vehicle 1 and the leading vehicle 2 is, the more the straddle-type vehicle 1 tends to be in the blind area within the field of view of the oncoming vehicle 3. Thus, for example, in the traveling position support operation, the execution section 22 may notify the rider that the recommended traveling position in the lane width direction is closer to the right side with respect to the current traveling position as the traveling position of the straddle-type vehicle 1 in the front-rear direction is closer to the leading vehicle 2.

Note that entrance of the straddle-type vehicle 1 into the blind area within the field of view of the oncoming vehicle 3 can be reduced not only by movement of the straddle-type vehicle 1 to the right side but also by movement of the straddle-type vehicle 1 to the rear side. Thus, in the traveling position support operation, the execution section 22 may recommend not only the traveling position of the straddle-type vehicle 1 in the lane width direction but also the traveling position of the straddle-type vehicle 1 in the front-rear direction to the rider. For example, in a case where the traveling position of the straddle-type vehicle 1 in the front-rear direction is excessively close to the leading vehicle 2, the execution section 22 may recommend, in the traveling position support operation, a traveling position on the right side and the rear side with respect to the current traveling position as the traveling position of the straddle-type vehicle 1.

Alternatively, the execution section 22 may execute the traveling position support operation, for example, based not only on the visibility determination result but also on blinker information on the straddle-type vehicle 1. The blinker information on the straddle-type vehicle 1 is information about a blinker of the straddle-type vehicle 1, and for example, may include information indicating whether a left blinker is turned on and information indicating whether a right blinker is turned on. For example, in a case where the left blinker is turned on, it can be determined that the rider intends to turn the straddle-type vehicle 1 left. Thus, in a case where the left blinker is turned on, the execution section 22 may recommend, for example, a left traveling position on the traveling lane in the traveling position support operation. Moreover, in a case where the left blinker is turned on, the execution section 22 may inhibit the traveling position support operation, for example, even in a case where it is determined that the visibility of the straddle-type vehicle 1 from the oncoming vehicle 3 is lower than the reference.

The traveling position information and the blinker information are included in traveling state information on the straddle-type vehicle 1. That is, the execution section 22 may execute the traveling position support operation based not only on the visibility determination result but also on the traveling state information on the straddle-type vehicle 1. The traveling state information on the straddle-type vehicle 1 is information about the traveling state of the straddle-type vehicle 1, and may be information other than the traveling position information and the blinker information.

Alternatively, the execution section 22 may execute the traveling position support operation, for example, based not only on the visibility determination result but also on the positional relationship information on the straddle-type vehicle 1 and the leading vehicle 2 and the positional relationship information on the straddle-type vehicle 1 and the oncoming vehicle 3.

For example, the execution section 22 can specify, based on the positional relationship information, such an area of the traveling position of the straddle-type vehicle 1 that the visibility of the straddle-type vehicle 1 from the oncoming vehicle 3 is at a higher level than the reference (i.e., the straddle-type vehicle 1 is not in the blind area or is in the blind area only for a short time within the field of view of the oncoming vehicle 3). The area changes according to, e.g., the position, distance, speed, acceleration, or jerk of the straddle-type vehicle 1 relative to the leading vehicle 2 or the passage time difference between the straddle-type vehicle 1 and the leading vehicle 2 and the position, distance, speed, acceleration, or jerk of the straddle-type vehicle 1 relative to the oncoming vehicle 3 or the passage time difference between the straddle-type vehicle 1 and the oncoming vehicle 3.

For example, in the traveling position support operation, the execution section 22 may recommend the traveling position in the lane width direction within the area. Note that as described above, the execution section 22 may recommend not only the traveling position of the straddle-type vehicle 1 in the lane width direction but also the traveling position of the straddle-type vehicle 1 in the front-rear direction to the rider in the traveling position support operation.

For example, the execution section 22 may recommend a traveling position different from the current traveling position in both the lane width direction and the front-rear direction in the traveling position support operation.

Note that the execution section 22 may execute the traveling position support operation based not only on the visibility determination result but also on one of the positional relationship information on the straddle-type vehicle 1 and the leading vehicle 2 or the positional relationship information on the straddle-type vehicle 1 and the oncoming vehicle 3. For example, the execution section 22 may specify, based on one of the positional relationship information on the straddle-type vehicle 1 and the leading vehicle 2 or the positional relationship information on the straddle-type vehicle 1 and the oncoming vehicle 3, such an area of the traveling position of the straddle-type vehicle 1 that the visibility of the straddle-type vehicle 1 from the oncoming vehicle 3 is at a higher level than the reference, and may execute the traveling position support operation based on the area.

Note that the example where the execution section 22 recommends the traveling position of the straddle-type vehicle 1 in the lane width direction in the traveling position support operation has been mainly described above. The execution section 22 may correct the traveling position of the straddle-type vehicle 1 in the lane width direction in the traveling position support operation. For example, the execution section 22 may correct (i.e., actively change), in the traveling position support operation, the traveling position of the straddle-type vehicle 1 in the lane width direction by, e.g., automatically turning a steering of the straddle-type vehicle 1, reducing an operation load on the steering, or generating vibration on the steering. Note that the execution section 22 may correct, in the traveling position support operation, not only the traveling position of the straddle-type vehicle 1 in the lane width direction, but also the traveling position of the straddle-type vehicle 1 in the front-rear direction. For example, the execution section 22 may correct (i.e., actively change), in the traveling position support operation, the traveling position of the straddle-type vehicle 1 in the front-rear direction by, e.g., automatically decelerating the straddle-type vehicle 1.

Note that the example where the traveling position support operation is executed in a case where it is determined that the oncoming lane is present and it is determined that the visibility of the straddle-type vehicle 1 from the oncoming vehicle 3 is lower than the reference has been described above. Note that a condition for executing the traveling position support operation is not limited to the above-described example. For example, the traveling position support operation may be executed only in a case where it is determined that the oncoming vehicle 3 is approaching the straddle-type vehicle 1 in addition to the execution condition. For example, the determination section 23 can determine, based on the surrounding environment information acquired from the other vehicles or the infrastructure equipment, whether the oncoming vehicle 3 is approaching the straddle-type vehicle 1.

### Effects of Control Apparatus

The effects of the control apparatus 20 according to the embodiment of the present invention will be described.

The control apparatus 20 includes the execution section 22 that executes the rider support operation for supporting driving by the rider, and further includes the determination section 23 that determines the visibility of the straddle-type vehicle 1 from the oncoming vehicle 3. The execution section 22 executes, based on the visibility determination result from the determination section 23, the traveling position support operation which is the rider support operation of recommending or correcting the traveling position of the straddle-type vehicle 1 in the lane width direction. With this configuration, entrance of the straddle-type vehicle 1 into the blind area within the field of view of the oncoming vehicle 3 can be reduced, and therefore, for example, occurrence of collision between the oncoming vehicle 3 and the straddle-type vehicle 1 can be reduced. Thus, the safety of the straddle-type vehicle 1 can be improved.

Preferably, in the control apparatus 20, the traveling position support operation is the rider support operation of recommending or correcting not only the traveling position of the straddle-type vehicle 1 in the lane width direction but also the traveling position of the straddle-type vehicle 1 in the front-rear direction. With this configuration, entrance of the straddle-type vehicle 1 into the blind area within the field of view of the oncoming vehicle 3 can be more effectively reduced, and therefore, the safety of the straddle-type vehicle 1 can be more effectively improved.

Preferably, in the control apparatus 20, the determination section 23 determines the visibility based on the image obtained by the camera (e.g., surrounding environment sensor 12) mounted on the straddle-type vehicle 1 and facing the front of the straddle-type vehicle 1. With this configuration, the visibility is properly determined.

Preferably, in the control apparatus 20, the determination section 23 determines the visibility based on the information on the size of the leading vehicle 2 on the image. With this configuration, the visibility is more properly determined.

Preferably, in the control apparatus 20, the determination section 23 determines the visibility based not only on the information on the size of the leading vehicle 2 on the image, but also on the information on the traveling position of the straddle-type vehicle 1 in the lane width direction. With this configuration, the visibility is much more properly determined.

Preferably, in the control apparatus 20, the determination section 23 determines the visibility based on the information on the timing of the image showing the oncoming vehicle 3. With this configuration, the visibility is more properly determined.

Preferably, in the control apparatus 20, the determination section 23 determines the visibility based on the positional relationship information on the straddle-type vehicle 1 and the leading vehicle 2. With this configuration, for example, such an area of the traveling position of the straddle-type vehicle 1 that the visibility is at a higher level than the reference is specified based on the positional relationship information, and therefore, the visibility is properly determined.

Preferably, in the control apparatus 20, the determination section 23 determines the visibility based on the positional relationship information on the straddle-type vehicle 1 and the oncoming vehicle 3. With this configuration, for example, such an area of the traveling position of the straddle-type vehicle 1 that the visibility is at a higher level than the reference is specified based on the positional relationship information, and therefore, the visibility is properly determined.

Preferably, in the control apparatus 20, the execution section 22 executes the traveling position support operation based not only on the visibility determination result but also on the traveling state information on the straddle-type vehicle 1. With this configuration, the traveling position support operation can be more properly executed according to the traveling state of the straddle-type vehicle 1.

Preferably, in the control apparatus 20, the traveling state information includes the traveling position information on the straddle-type vehicle 1. Entrance of the straddle-type vehicle 1 into the blind area within the field of view of the oncoming vehicle 3 can be more effectively reduced, and therefore, the safety of the straddle-type vehicle 1 can be more effectively improved.

Preferably, in the control apparatus 20, the traveling state information includes the blinker information on the straddle-type vehicle 1. With this configuration, the traveling position support operation can be more properly executed considering the rider's intention to turn the straddle-type vehicle 1 right or left.

Preferably, in the control apparatus 20, the execution section 22 executes the traveling position support operation based not only on the visibility determination result but also on the positional relationship information on the straddle-type vehicle 1 and the leading vehicle 2. With this configuration, for example, such an area of the traveling position of the straddle-type vehicle 1 that the visibility is at a higher level than the reference is specified based on the positional relationship information, and therefore, the traveling position of the straddle-type vehicle 1 can be more properly recommended or corrected. Thus, entrance of the straddle-type vehicle 1 into the blind area within the field of view of the oncoming vehicle 3 can be more effectively reduced, and therefore, the safety of the straddle-type vehicle 1 can be more effectively improved.

Preferably, in the control apparatus 20, the execution section 22 executes the traveling position support operation based not only on the visibility determination result but also on the positional relationship information on the straddle-type vehicle 1 and the oncoming vehicle 3. With this configuration, such an area of the traveling position of the straddle-type vehicle 1 that the visibility is at a higher level than the reference is specified based on the positional relationship information, and therefore, the traveling position of the straddle-type vehicle 1 can be more properly recommended or corrected. Thus, entrance of the straddle-type vehicle 1 into the blind area within the field of view of the oncoming vehicle 3 can be more effectively reduced, and therefore, the safety of the straddle-type vehicle 1 can be more effectively improved.

The present invention is not limited to description of the embodiment. For example, only part of the embodiment may be implemented. Note that the case where a road traffic is regulated as a left-hand traffic has been described above, but the present invention is similarly applicable to a case where the road traffic is regulated as a right-hand traffic.

### REFERENCE SIGNS LIST

1: Straddle-type vehicle
2: Leading vehicle
3: Oncoming vehicle
10: Rider support system
11: Display apparatus
12: Surrounding environment sensor
20: Control apparatus
21: Acquisition section
22: Execution section
23: Determination section
L1: Lane
L2: Lane
LV: Lane boundary

1. A control apparatus (20) for a rider support system (10) for supporting driving of a straddle-type vehicle (1) by a rider, the control apparatus configured to:
execute a rider support operation for supporting driving by the rider; and
determine a visibility of the straddle-type vehicle (1) from an oncoming vehicle (3),
wherein the control apparatus (20) executes, based on a visibility determination result, a traveling position support operation which is the rider support operation of recommending or correcting a traveling position of the straddle-type vehicle (1) in a lane width direction.

2. The control apparatus according to claim 1, wherein
the traveling position support operation is the rider support operation of recommending or correcting not only the traveling position of the straddle-type vehicle (1) in the lane width direction but also a traveling position of the straddle-type vehicle (1) in a front-rear direction.

3. The control apparatus according to claim 1, wherein
the control apparatus (20) determines the visibility based on an image obtained from a camera (12) mounted to the straddle-type vehicle (1) and facing a front of the straddle-type vehicle (1).

4. The control apparatus according to claim 3, wherein
the control apparatus (20) determines the visibility based on information on a size of a leading vehicle (2) on the image.

5. The control apparatus according to claim 4, wherein
the control apparatus (20) determines the visibility based not only on the information on the size of the leading vehicle (2) on the image but also on information on the traveling position of the straddle-type vehicle (1) in the lane width direction.

6. The control apparatus according to claim 3, wherein
the control apparatus (20) determines the visibility based on information on timing of the image showing the oncoming vehicle (3).

7. The control apparatus according to claim 1, wherein
the control apparatus (20) determines the visibility based on positional relationship information on the straddle-type vehicle (1) and a leading vehicle (2).

8. The control apparatus according to claim 1, wherein
the control apparatus (20) determines the visibility based on positional relationship information on the straddle-type vehicle (1) and the oncoming vehicle (3).

9. The control apparatus according to claim 1, wherein
the control apparatus (20) executes the traveling position support operation based not only on the visibility determination result but also on traveling state information on the straddle-type vehicle (1).

10. The control apparatus according to claim 9, wherein
the traveling state information includes traveling position information on the straddle-type vehicle (1).

11. The control apparatus according to claim 9, wherein
the traveling state information includes blinker information on the straddle-type vehicle (1).

12. The control apparatus according to claim 1, wherein
the control apparatus (20) executes the traveling position support operation based not only on the visibility determination result but also on positional relationship information on the straddle-type vehicle (1) and a leading vehicle (2).

13. The control apparatus according to claim 1, wherein the control apparatus (20) executes the traveling position support operation based not only on the visibility determination result but also on positional relationship information on the straddle-type vehicle (1) and the oncoming vehicle (3).

14. A control method for a rider support system (10) for supporting driving of a straddle-type vehicle (1) by a rider, comprising:
executing, via a control apparatus (20), a rider support operation for supporting the driving by the rider; and
determining, via the control apparatus (20), a visibility of the straddle-type vehicle (1) from an oncoming vehicle (3),
wherein the control apparatus (20) executes, based on a visibility determination result, a traveling position support operation which is the rider support operation of recommending or correcting a traveling position of the straddle-type vehicle (1) in a lane width direction.
